(19) United States
(12) Patent Application Publication
(10) Pub. No.: US 2022/0382544 A1
(43) Pub. Date: Dec. 1, 2022

(54) ARITHMETIC DEVICE, METHOD, AND PROGRAM

(71) Applicant: FUJIFILM Corporation, Tokyo (JP)

(72) Inventor: Satoshi IHARA, Tokyo (JP)

(73) Assignee: FUJIFILM Corporation, Tokyo (JP)

(21) Appl. No.: 17/732,537

(22) Filed: Apr. 29, 2022

(30) Foreign Application Priority Data
May 28, 2021 (JP) 2021-090400

(51) Int. Cl. G06F 9/30; G06F 7/499

(52) U.S. Cl. CPC G06F 9/3001; G06F 7/49915; G06F 7/49942

(57) ABSTRACT

A processor determines an exponent common to a plurality of numerical values, determines a mantissa for each of the plurality of numerical values based on the determined exponent, and performs four arithmetic operations using a sign, the determined exponent, and the determined mantissa.

### CROSS-REFERENCE TO RELATED APPLICATIONS

The present application claims priority under 35 U.S.C. § 119 to Japanese Patent Application No. 2021-090400 filed on May 28, 2021. Each of the above application is hereby expressly incorporated by reference, in its entirety, into the present application.

### BACKGROUND OF THE INVENTION

1. Field of the Invention

The present disclosure relates to an arithmetic device, method, and a non-transitory computer readable recording medium storing a program.

2. Description of the Related Art

In recent years, a machine learning technique using deep learning has been attracting attention. In particular, there are various proposed methods for extracting a desired area contained in an image by using a trained neural network constructed by learning of a convolutional neural network (hereinafter referred to as CNN), which is one of multi-layer neural networks in which a plurality of processing layers are hierarchically connected, using deep learning (refer to, for example, JP2019-067299A).

The CNN consists of the plurality of processing layers. The processing layer performs a convolution operation using various kernels on an input image and outputs a feature map consisting of feature amount data obtained by the convolution operation. The kernel has an n×n pixel size (for example, n=3), and a weighting coefficient is set for each element. Specifically, a weighting coefficient such as a differential filter that emphasizes an edge of the input image is set. In a convolution layer, the convolution operation is performed by applying the kernel to the entire input image or feature map output from the processing layer in a previous stage while shifting an attention pixel of the kernel. In this case, a product-sum operation is performed between a pixel value of each pixel of the input image or the feature map output from the processing layer in the previous stage and the set weighting coefficient of the kernel.

The processing performed by such a CNN requires a large amount of calculation, and an amount of memory used by a computer at a time of execution is also large. For this reason, various ideas for performing the calculation on the computer have been proposed. For example, in JP1996-087399A (JP-H8-087399A), a method has been proposed in which two numerical values to be calculated are divided into signs, exponents, and mantissas according to a standard format defined by IEEE-754, which is a method of expressing a floating-point number on a computer, the exponents of the two numerical values to be calculated are matched to a larger exponent, and then the calculation is performed. Further, in JP2019-212295A, a method has been proposed in which a training tensor for a neural network is generated by using a 16-bit floating-point number including a 1-bit sign, a 5-bit exponent, and a 10-bit mantissa in a case where learning of the neural network is performed, while a 32-bit numerical value is used in the training tensor for the neural network.

### SUMMARY OF THE INVENTION

However, in the method described in JP1996-087399A (JP-H8-087399A), the amount of calculation using the floating-point number is not reduced. Further, in the method described in JP2019-212295A, since the training tensor for the neural network itself is composed of 16 bits, the calculation accuracy is lower than that of 32 bits.

The present disclosure has been made in view of the above circumstances, and an object of the present disclosure is to perform a floating-point number calculation with high accuracy while reducing an amount of calculation.

An arithmetic device according to the present disclosure performs four arithmetic operations on a plurality of numerical values each consisting of a floating-point number expressed by a sign, an exponent, and a mantissa.
The arithmetic device comprises at least one processor.
The processor determines an exponent common to the plurality of numerical values,
determines a mantissa for each of the plurality of numerical values based on the determined exponent, and
performs the four arithmetic operations using the sign, the determined exponent, and the determined mantissa.

In the arithmetic device according to the present disclosure, the processor may determine a largest exponent in the plurality of numerical values as the common exponent.

In the arithmetic device according to the present disclosure, in a case where the four arithmetic operations are performed between the plurality of numerical values and one or more other numerical values consisting of floating-point numbers expressed by signs, exponents, and mantissas,
the processor may perform the four arithmetic operations between the determined exponent and the exponents of other numerical values and between the determined mantissa and the mantissas of other numerical values.

In the arithmetic device according to the present disclosure, the plurality of numerical values may be input values input to one or more processing layers configuring a neural network.

The one or more other numerical values may be coefficients applied to the input value in the processing layer.

In this case, the input value may be an image input to the processing layer of the neural network or a feature map processed by a processing layer in a previous stage of the processing layer, and
the coefficient may be a weighting coefficient of a kernel that convolves the image or the feature map in the processing layer.

In the arithmetic device according to the present disclosure, the processor may determine a common exponent for at least one of the input value or the coefficient in each of one or more processing layers as an exponent set in advance.

In the arithmetic device according to the present disclosure, the processor may perform the four arithmetic operations using a plurality of upper bits set in advance in the mantissa.

In the arithmetic device according to the present disclosure, the plurality of numerical values may be 32-bit floating-point numbers, and each of the plurality of numerical values may include a 1-bit sign, an 8-bit exponent, and a 23-bit mantissa.

In the arithmetic device according to the present disclosure, the plurality of numerical values may be 32-bit floating-point numbers, each of the plurality of numerical values may include a 1-bit sign, an 8-bit exponent, and a 23-bit mantissa, and the plurality of upper bits may be 16 bits.

A non-transitory computer readable recording medium storing an arithmetic program according to the present disclosure is an arithmetic program that causes a computer to perform four arithmetic operations on a plurality of numerical values each consisting of a floating-point number expressed by a sign, an exponent, and a mantissa.
The arithmetic program causes the computer to execute a procedure of determining an exponent common to the plurality of numerical values,
a procedure of determining a mantissa for each of the plurality of numerical values based on the determined exponent, and
a procedure of performing the four arithmetic operations using the sign, the determined exponent, and the determined mantissa.

According to the present disclosure, the floating-point number calculation is possible with high accuracy while reducing the amount of calculation.

### BRIEF DESCRIPTION OF THE DRAWINGS

FIG. 1 is a diagram showing a schematic configuration of a diagnosis support system to which an arithmetic device according to the embodiment of the present disclosure is applied.

FIG. 2 is a diagram showing a schematic configuration of the arithmetic device according to the present embodiment.

FIG. 3 is a functional configuration diagram of the arithmetic device according to the present embodiment.

FIG. 4 is a diagram schematically showing a configuration of a CNN.

FIG. 5 is a diagram schematically showing a 32-bit floating-point number.

FIG. 6 is a diagram schematically showing a feature map.

FIG. 7 is a diagram schematically showing a kernel.

FIG. 8 is a diagram showing a display screen.

FIG. 9 is a flowchart showing a process performed in the present embodiment.

### DESCRIPTION OF THE PREFERRED EMBODIMENTS

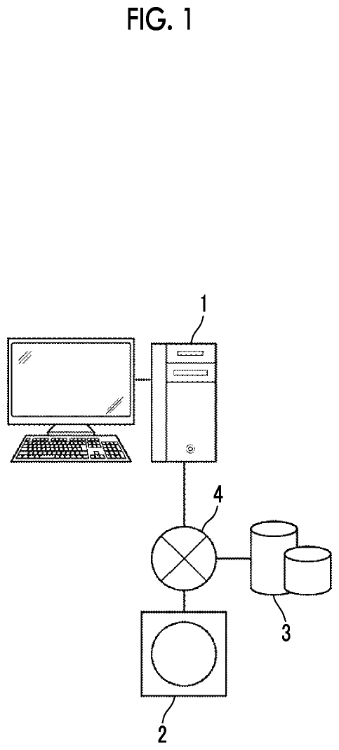

Hereinafter, embodiments of the present disclosure will be described with reference to the drawings. FIG. 1 is a hardware configuration diagram showing an outline of a diagnosis support system to which an arithmetic device according to a first embodiment of the present disclosure is applied. As shown in FIG. 1, in the diagnosis support system, a computer 1 encompassing the arithmetic device according to the present embodiment, an imaging device 2, and an image storage server 3 are connected in a communicable state via a network 4.

The computer 1 encompasses the arithmetic device according to the present embodiment, and an arithmetic program of the present embodiment is installed in the computer 1. The computer 1 may be a workstation or a personal computer directly operated by a doctor performing diagnosis, or may be a server computer connected to the workstation or the personal computer via a network. The arithmetic program is stored in a storage device of the server computer connected to the network or in a network storage in a state of being accessible from the outside, and is downloaded to and installed in the computer 1 used by a doctor in response to a request. Alternatively, the arithmetic program is recorded on a recording medium such as a digital versatile disc (DVD) or a compact disc read only memory (CD-ROM), is distributed, and is installed in the computer 1 from the recording medium.

The imaging device 2 images a site to be diagnosed of a subject to generate a three-dimensional image representing the site and is specifically a computed tomography (CT) device, a magnetic resonance imaging (MRI) device, a positron emission tomography (PET) device, and the like. The three-dimensional image consisting of a plurality of sliced images, which is generated by the imaging device 2, is transmitted to and stored in the image storage server 3. In the present embodiment, the imaging device 2 is the CT device and generates, for example, a CT image of a thoracoabdominal part of a patient as the three-dimensional image.

The image storage server 3 is a computer that stores and manages various data and comprises a large-capacity external storage device and software for database management. The image storage server 3 communicates with another device via the wired or wireless network 4 to transmit and receive image data and the like. Specifically, the image storage server 3 acquires various data including the image data of a medical image generated by the imaging device 2 via the network and stores the acquired data in the recording medium such as the large-capacity external storage device for management. A storage format of the image data and the communication between the devices via the network 4 are based on a protocol such as digital imaging and communication in medicine (DICOM).

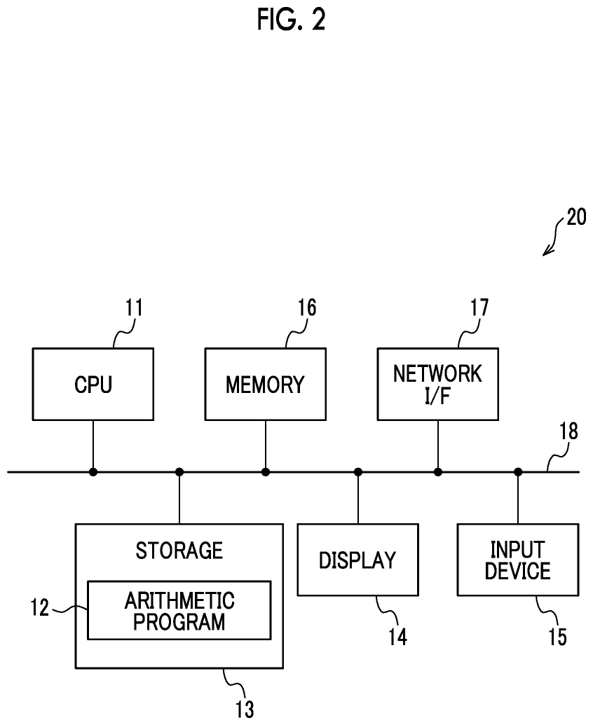

Next, the arithmetic device according to the present embodiment will be described. FIG. 2 describes the hardware configuration of the arithmetic device according to the present embodiment. As shown in FIG. 2, an arithmetic device 20 includes a central processing unit (CPU) 11, a nonvolatile storage 13, and a memory 16 as a temporary storage area. Further, the arithmetic device 20 includes a display 14 such as a liquid crystal display, an input device 15 such as a keyboard and a mouse, and a network interface (I/F) 17 connected to the network 4. The CPU 11, the storage 13, the display 14, the input device 15, the memory 16, and the network I/F 17 are connected to a bus 18. The CPU 11 is an example of a processor in the present disclosure.

The storage 13 is formed by a hard disk drive (HDD), a solid state drive (SSD), a flash memory, and the like. The storage 13 as a storage medium stores the arithmetic program. The CPU 11 reads out an arithmetic program 12 from the storage 13, expands the program into the memory 16, and executes the expanded arithmetic program 12.

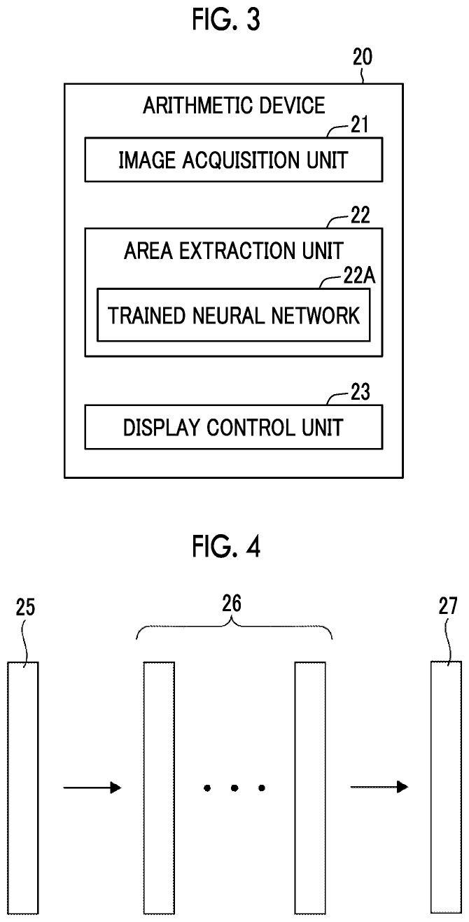

Next, a functional configuration of the arithmetic device according to the present embodiment will be described. FIG. 3 is a diagram showing the functional configuration of the arithmetic device according to the present embodiment. The arithmetic device 20 according to the present embodiment is for extracting a target area from an input image. As shown in FIG. 3, the arithmetic device 20 comprises an image acquisition unit 21, an area extraction unit 22, and a display control unit 23. The CPU 11 executes the arithmetic program 12 to function as the image acquisition unit 21, the area extraction unit 22, and the display control unit 23.

The image acquisition unit 21 acquires a target image G0 to be processed from the image storage server 3 in response to an instruction from the input device 15 by a diagnostic reading doctor who is an operator.

The area extraction unit 22 extracts the target area from the target image G0. For example, the area extraction unit 22 extracts a target area set in advance, such as a lung area or a liver area, from the target image G0. For this purpose, the area extraction unit 22 has a trained neural network 22A constructed by machine learning of a neural network so as to extract the target area from the target image G0.

In the present embodiment, the trained neural network 22A consists of a convolutional neural network (CNN) in which machine learning is performed by deep learning or the like using teacher data such that the target area is extracted for each pixel of the target image G0.

FIG. 4 is a diagram schematically showing a configuration of the CNN. As shown in FIG. 4, the CNN consists of, for example, a plurality of processing layers including an input layer 25, a plurality of interlayers 26, and an output layer 27. The processing layer performs a convolution operation using various kernels on the input image or a feature map input from the processing layer in a previous stage and outputs a feature map consisting of feature amount data obtained by the convolution operation. The kernel has an n×n pixel size (for example, n=3), and a weighting coefficient is set for each element. Specifically, a weighting coefficient such as a differential filter that emphasizes an edge of the input image is set. In a convolution layer, the convolution operation is performed by applying the kernel to the entire input image or feature map output from the processing layer in the previous stage while shifting an attention pixel of the kernel to output the feature map.

The CNN performs the convolution operation and a deconvolution operation on the feature map by the plurality of processing layers to output a probability of being the target area for each pixel of the input image is the target area as a score. The area extraction unit 22 extracts, from the target image G0, an area consisting of pixels whose score is equal to or higher than a threshold value set in advance as the target area.

Such a convolution operation in the processing layer of the CNN is a product-sum operation between a pixel value of each pixel of the input image or the feature map input from the processing layer in the previous stage and the weighting coefficient of the kernel. Hereinafter, the input image and the feature map input from the processing layer in the previous stage may be simply represented by the feature map.

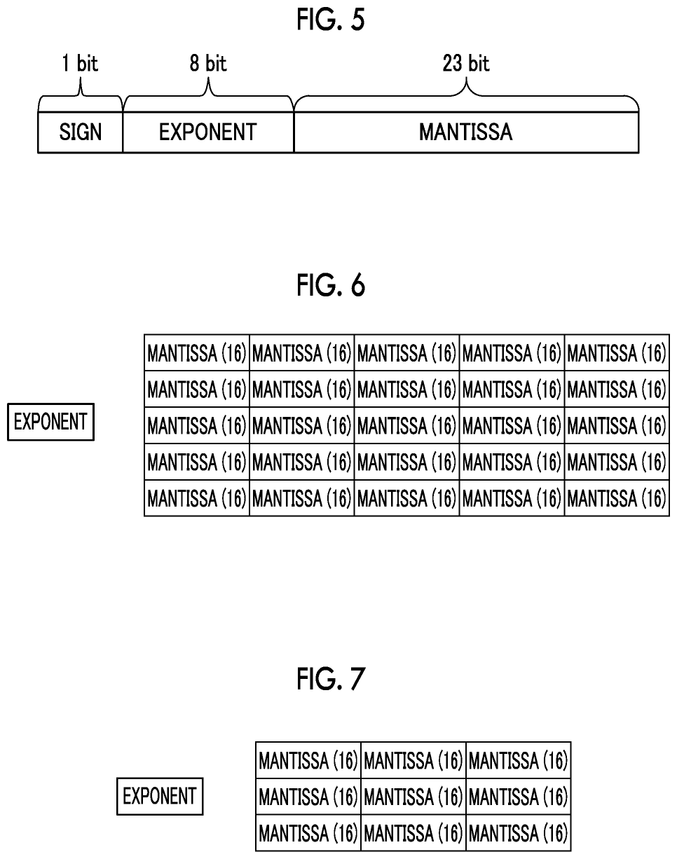

In the present embodiment, the pixel value of each pixel of the feature map is represented by a 32-bit floating-point number. The weighting coefficient of the kernel is also represented by the 32-bit floating-point number. FIG. 5 is a diagram schematically showing the 32-bit floating-point number. As shown in FIG. 5, the 32-bit floating-point number consists of a 1-bit sign, an 8-bit exponent, and a 23-bit mantissa. In a case where the exponent is n and the mantissa is a, the 32-bit floating-point number can be represented by ±a×10⁻ⁿ.

Numerical values used in one processing layer of the CNN are close to each other in each pixel, and values of the exponent are substantially the same. Therefore, the area extraction unit 22 determines a common exponent for each pixel value of the feature map. Specifically, a largest exponent among a plurality of pixel values is determined as the common exponent. For example, for three pixel values of 0.7×10⁻³, 0.3×10⁻⁷, and 0.5×10⁻⁵, the largest exponent of −3 is determined as the common exponent. Further, the area extraction unit 22 determines the mantissa of each pixel value based on the determined exponent. For example, for the three pixel values of 0.7×10⁻³, 0.3×10⁻⁷, and 0.5×10⁻⁵, in a case where the common exponent is −3, each can be represented by 0.7×10⁻³, 0.00003×10⁻³, 0.005×10⁻³. Therefore, 0.7, 0.00003, and 0.005 are determined as mantissas for the three pixel values, respectively. The arithmetic device 20 performs the four arithmetic operations using the sign, the determined exponent, and the determined mantissa.

The pixel value of the image input to the CNN has a predetermined range, for example, 8 bits or 10 bits. Therefore, the numerical values used in each processing layer of the CNN are substantially the same size as long as the range of the pixel value of the images to be processed is the same. Therefore, the area extraction unit 22 may determine the common exponent of the image or feature map input to each processing layer of the CNN as an exponent set in advance. For example, in the CNN shown in FIG. 4, the common exponent may be determined as the exponent set in advance such as −3 for the input layer 25, −6 for one of the interlayers 26, and −3 for the output layer 27. The pixel value of the image input to the CNN is an example of “input values input to one or more processing layers configuring a neural network”.

The trained neural network 22A changes the pixel value of the feature map to a 16-bit mantissa using upper 16 bits of the determined mantissa. Therefore, for example, in a case where the size of the feature map is 5×5 pixels, the feature map can be represented as shown in FIG. 6 using exponents and mantissas. In FIG. 6, (16) indicates a 16-bit value.

The area extraction unit 22 determines the common exponent for the weighting coefficient of the kernel in the same manner and determines the mantissa of each pixel value based on the determined exponent. Further, the area extraction unit 22 sets the weighting coefficient for the determined mantissa using the upper 16 bits. Therefore, for example, in a case where the size of the kernel is 3×3 pixels, the weighting coefficient of the kernel can be represented as shown in FIG. 7 using the exponent and the mantissa. In FIG. 7, (16) indicates a 16-bit value. The weighting coefficient of the kernel is an example of one of “coefficients applied to the input value in the processing layer”.

The weighting coefficient of the kernel is not changed in the trained neural network 22A. Therefore, in the present embodiment, the common exponent and mantissa are assumed to be set in advance for the weighting coefficient of the kernel.

In a case where such a convolution operation between the feature map and the kernel is performed, the product-sum operation between the pixel value of the feature map and the weighting coefficient of the kernel is performed. The product of the pixel value of the feature map and the weighting coefficient of the kernel is performed by adding the exponents and multiplying the mantissas. That is, in a case where the pixel value of the feature map is a×10⁻ⁿ and kernel weighting coefficient is b×10^{-m}, a multiplication value is (a×b)×10^{-(n+m)}. The pixel value of the feature map is an example of “a plurality of numerical values each consisting of a floating-point number expressed by a sign, an exponent, and a mantissa”. The kernel weighting coefficient is an example of “one or more other numerical values consisting of floating-point numbers expressed by signs, exponents, and mantissas”. The product-sum operation between the pixel value of the feature map and the weighting coefficient of the kernel is an example of “the four arithmetic operations performed between the plurality of numerical values and one or more other numerical values”.

On the other hand, in the convolution operation, the product of the pixel value of the feature map and the weighting coefficient of the kernel is added. In a case where two values to be added are c×10^{-(n+m)} and d×10^{-(n+m)}, an addition value is (c+d)×10^{-(n+m)}. The calculation result of the mantissa is 32 bits, but assumed to be rounded to a 16-bit value.

In the trained neural network 22A of the area extraction unit 22, the convolution operations and the deconvolution operations between the target image G0 and feature map and the kernel of each processing layer are performed as described above. The trained neural network 22A outputs the probability of being the target area for each pixel of the target image G0 as the score. The area extraction unit 22 extracts the area consisting of pixels whose score is equal to or higher than the threshold value set in advance in the target image G0 as the target area.

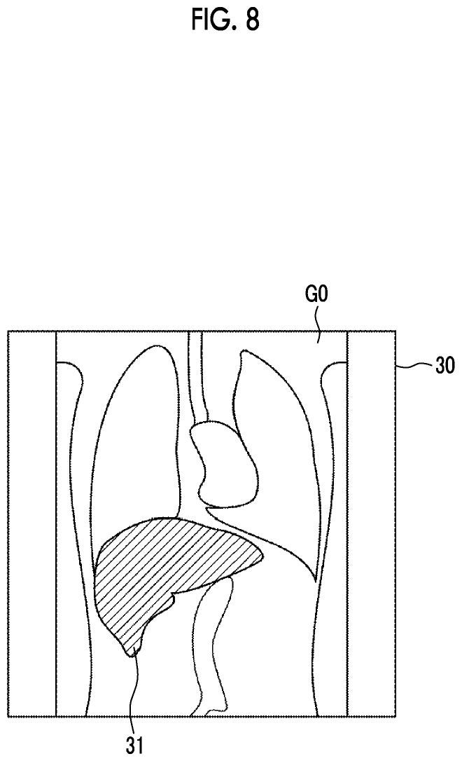

The display control unit 23 displays the target image G0 from which the target area is extracted. FIG. 8 is a diagram showing a display screen of the target image. As shown in FIG. 8, the target image G0 is displayed on a display screen 30. For example, the target image G0 is a CT image of a coronal cross section of the thoracoabdominal part of a human body. A mask 31 is assigned to the liver, which is the target area, and the mask is not assigned to an area other than the liver. Accordingly, the liver area is found to be extracted in the target image G0.

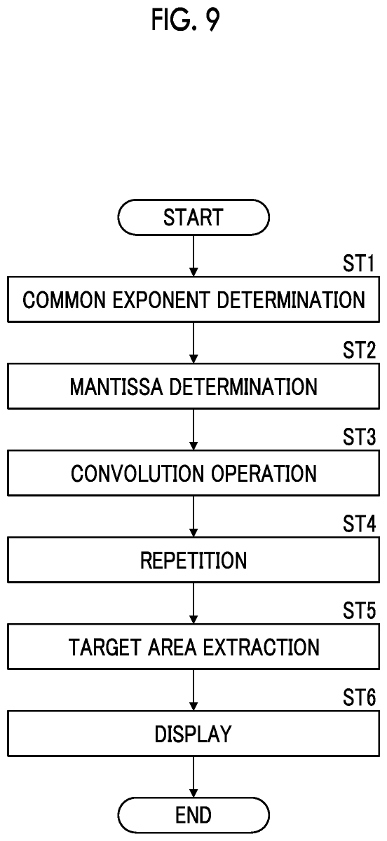

Next, the processing performed in the present embodiment will be described. FIG. 9 is a flowchart showing the processing performed in the present embodiment. The target image G0 to be processed is assumed to be acquired by the image acquisition unit 21 and stored in the storage 13. First, the area extraction unit 22 determines the common exponent for each pixel of the target image G0 (step ST1). The area extraction unit 22 determines the mantissa for each pixel value of the target image G0 based on the determined exponent (step ST2). The trained neural network 22A of the area extraction unit 22 performs the convolution operation between the target image G0 and the kernel using the determined exponent and the determined mantissa (step ST3). As for the weighting coefficient of the kernel, the common exponent and mantissa are set in advance as described above. Accordingly, the feature map is output from the processing layer of the trained neural network 22A.

The determination of the common exponent, the determination of the mantissa based on the determined exponent, and the convolution operation are repeated, by the area extraction unit 22, the same number of times as the number of processing layers included in the trained neural network 22A (step ST4). Accordingly, the score of being the target area for each pixel of the target image G0 is derived from the trained neural network 22A. The area extraction unit 22 extracts the target area from the target image G0 based on the score (step ST5). Further, the display control unit 23 displays the target image G0 from which the target area has been extracted on the display 14 (step ST6), and the processing ends.

As described above, in the present embodiment, the common exponent in the pixel values of each pixel of the image and the feature map input to the trained neural network 22A is determined, the mantissa of the pixel value is determined based on the determined exponent, and the convolution operation in the processing layer of the trained neural network 22A is performed by using the determined exponent and the determined mantissa.

Therefore, the amount of calculation in a case where the product-sum operation is performed between the pixel value and the weighting coefficient of the kernel can be reduced. As for the mantissa, since only 16 bits of 23 bits in the 32-bit floating-point number are used, the amount of memory used at the time of calculation can be reduced as compared with a case where the mantissa of 23 bits is used as it is. Further, the accuracy of the calculation can be improved as compared with a case where the calculation is performed using the 16-bit floating-point number. Accordingly, in the present embodiment, the convolution operation can be performed with high accuracy while reducing the amount of calculation. Therefore, according to the present embodiment, the calculation of extracting the target area from the target image G0 can be performed at high speed and with high accuracy.

The common exponent for the input image or feature map is determined as the exponent set in advance in each processing layer of the CNN. Therefore, a processing time for determining the exponent can be shortened. Therefore, the calculation can be performed at higher speed.

In a case where the processing is performed by the CPU 11, the processing is performed according to single instruction/multiple data (SIMD). The SIMD is a method of applying one command to a plurality of data at the same time and performing the processing in parallel and may be referred to as vector operation or vector processing. In a case where the CPU 11 used in the present embodiment has a register width of 128 bits, four 32-bit floating-point numbers can be processed simultaneously. On the other hand, in the present embodiment, since the upper 16 bits of the 23 bits of the mantissa are used, eight pieces of processing can be processed simultaneously. From this viewpoint as well, according to the present embodiment, the calculation of extracting the target area from the target image G0 can be performed at high speed.

In the above embodiment, the trained neural network 22A is used to perform the processing of extracting the target area from the target image, but the present disclosure is not limited thereto. With the machine learning of the convolutional neural network, the technique of the present disclosure can be applied to the convolution operation in the trained neural network 22A that performs any processing such as image processing.

In the above embodiment, the arithmetic device according to the present embodiment is applied to the calculation in the trained neural network whose processing target is the image, but the present disclosure is not limited thereto. The arithmetic device according to the present embodiment can also be applied to the calculation in a trained neural network that performs predetermined processing on voice, text, video, and the like.

In the above embodiment, the arithmetic device according to the present embodiment is applied to the calculation between the feature map and the kernel in the convolutional neural network, but the present disclosure is not limited thereto. The arithmetic device according to the present embodiment can be applied to all four arithmetic operations using floating-point numbers.

In the above embodiment, the numerical value is the 32-bit floating-point number, but the number of bits of the numerical value is not limited thereto and may be any number of bits.

In the above embodiment, as a hardware structure of the processing units that execute various types of processing such as the image acquisition unit 21, the area extraction unit 22, and the display control unit 23, the following various processors can be used. The various processors include a programmable logic device (PLD) which is a processor whose circuit configuration is changeable after manufacturing such as a field programmable gate array (FPGA), a dedicated electric circuit which is a processor having a circuit configuration exclusively designed to execute specific processing such as an application specific integrated circuit (ASIC), and the like, in addition to the CPU which is a general-purpose processor that executes software (program) to function as various processing units, as described above.

One processing unit may be configured by one of the various processors or a combination of two or more processors of the same type or different types (for example, a combination of a plurality of FPGAs or a combination of a CPU and an FPGA). The plurality of processing units may be configured of one processor.

As an example of configuring the plurality of processing units with one processor, first, there is a form in which one processor is configured by a combination of one or more CPUs and software and the processor functions as the plurality of processing units, as represented by computers such as a client and a server. Second, there is a form in which a processor that realizes the functions of the entire system including the plurality of processing units with one integrated circuit (IC) chip is used, as represented by a system-on-chip (SoC) or the like. As described above, the various processing units are configured using one or more of the various processors as the hardware structure.

Further, more specifically, a circuitry combining circuit elements such as semiconductor elements can be used as the hardware structure of the various processors.

### EXPLANATION OF REFERENCES

1: computer

2: imaging device

3: image storage server

4: network

11: CPU

12: arithmetic program

13: storage

14: display

15: input device

16: memory

17: network I/F

18: bus

20: arithmetic device

21: image acquisition unit

22: area extraction unit

22A: trained neural network

23: display control unit

25: input layer

26: interlayer

27: output layer

30: display screen

31: mask

G0: target image

What is claimed is:

1. An arithmetic device that performs four arithmetic operations on a plurality of numerical values each consisting of a floating-point number expressed by a sign, an exponent, and a mantissa, the device comprising:
at least one processor,
wherein the processor is configured to:
determine an exponent common to the plurality of numerical values;
determine a mantissa for each of the plurality of numerical values based on the determined exponent; and
perform the four arithmetic operations using the sign, the determined exponent, and the determined mantissa.

2. The arithmetic device according to claim 1,
wherein the processor is configured to determine a largest exponent in the plurality of numerical values as the common exponent.

3. The arithmetic device according to claim 1,
wherein in a case where the four arithmetic operations are performed between the plurality of numerical values and one or more other numerical values consisting of floating-point numbers expressed by signs, exponents, and mantissas,
the processor is configured to perform the four arithmetic operations between the determined exponent and the exponents of other numerical values and between the determined mantissa and the mantissas of other numerical values.

4. The arithmetic device according to claim 3,
wherein the plurality of numerical values are input values input to one or more processing layers configuring a neural network, and
the one or more other numerical values are coefficients applied to the input value in the processing layer.

5. The arithmetic device according to claim 4,
wherein the input value is an image input to the processing layer of the neural network or a feature map processed by a processing layer in a previous stage of the processing layer, and
the coefficient is a weighting coefficient of a kernel that convolves the image or the feature map in the processing layer.

6. The arithmetic device according to claim 4,
wherein the processor is configured to determine a common exponent for at least one of the input value or the coefficient in each of one or more processing layers as an exponent set in advance.

7. The arithmetic device according to claim 1,
wherein the processor is configured to perform the four arithmetic operations using a plurality of upper bits set in advance in the mantissa.

8. The arithmetic device according to claim 1,
wherein the plurality of numerical values are 32-bit floating-point numbers, and each of the plurality of numerical values includes a 1-bit sign, an 8-bit exponent, and a 23-bit mantissa.

9. The arithmetic device according to claim 7,
wherein the plurality of numerical values are 32-bit floating-point numbers, each of the plurality of numerical values includes a 1-bit sign, an 8-bit exponent, and a 23-bit mantissa, and the plurality of upper bits are 16 bits.

10. An arithmetic method that performs four arithmetic operations on a plurality of numerical values each consisting of a floating-point number expressed by a sign, an exponent, and a mantissa, the method comprising:
determining an exponent common to the plurality of numerical values;
determining a mantissa for each of the plurality of numerical values based on the determined exponent; and
performing the four arithmetic operations using the sign, the determined exponent, and the determined mantissa.

11. A non-transitory computer readable recording medium storing an arithmetic program that causes a computer to perform four arithmetic operations on a plurality of numerical values each consisting of a floating-point number expressed by a sign, an exponent, and a mantissa, the program causing the computer to execute:
determining an exponent common to the plurality of numerical values;
determining a mantissa for each of the plurality of numerical values based on the determined exponent; and
performing the four arithmetic operations using the sign, the determined exponent, and the determined mantissa.
